(19) United States
(12) Patent Application Publication
(10) Pub. No.: US 2025/0174680 A1
(43) Pub. Date: May 29, 2025

(54) Bipolar plate for an electrochemical unit of an electrochemical device and electrochemical device

(71) Applicant: EKPO Fuel Cell Technologies GmbH, Dettingen (DE)

(72) Inventors: Michael SCHAICH, Dettingen (DE); Joachim SCHERER, Dettingen (DE); Leander HESS, Dettingen (DE); Simon GRÜNENWALD, Dettingen (DE)

(21) Appl. No.: 19/040,383

(22) Filed: Jan. 29, 2025

Related U.S. Application Data
(63) Continuation of application No. PCT/EP2023/069814, filed on Jul. 17, 2023.

(30) Foreign Application Priority Data
Aug. 1, 2022 (DE) 10 2022 119 219.9

(51) Int. Cl. H01M 8/0265

(52) U.S. Cl. CPC H01M 8/0265

(57) ABSTRACT

In order to create a bipolar plate for an electrochemical unit of an electrochemical device comprising a plurality of electrochemical units that follow one another along a stack direction, wherein the bipolar plate comprises the following:
at least one medium passage opening, which forms a constituent part of a medium channel that extends along the stack direction through the electrochemical device;
a sealing bead, which extends around the medium passage opening;
a plurality of medium inlets, which are arranged on an inner side of the sealing bead facing toward the medium passage opening and which enable medium to flow into an interior space of the sealing bead; and
a plurality of medium outlets, which are arranged on an outer side of the sealing bead facing away from the medium passage opening and which enable medium to flow out of the interior space of the sealing bead,
   in which bipolar plate the pressure loss that occurs when the medium flows from the medium passage opening through the medium inlets, the interior space of the sealing bead, and the medium outlets is as low as possible and wherein the medium preferably flows out of the medium outlets distributed as uniformly as possible over a medium inlet region of a medium distribution region, it is proposed that the total cross-section of the medium inlets that is able to be flowed through is at least 10% greater than the total cross-section of the medium outlets that is able to be flowed through.

### RELATED APPLICATIONS

This application is a continuation of international application number PCT/EP2023/069814 filed on 17 Jul. 2023 and claims the benefit of German application number 10 2022 119 219.9 filed on 1 Aug. 2022.

The present disclosure relates to the subject matter disclosed in international application number PCT/EP2023/069814 of 17 Jul. 2023 and German application number 10 2022 119 219.9 of 1 Aug. 2022, which are incorporated herein by reference in their entirety and for all purposes.

### FIELD OF THE DISCLOSURE

The present invention relates to a bipolar plate for an electrochemical unit of an electrochemical device comprising a plurality of electrochemical units that follow one another along a stack direction, wherein the bipolar plate comprises the following:
at least one medium passage opening, which forms a constituent part of a medium channel that extends along the stack direction through the electrochemical device;
a sealing bead, which extends around the medium passage opening;
a plurality of medium inlets, which are arranged on an inner side of the sealing bead facing toward the medium passage opening and which enable medium to flow into an interior space of the sealing bead; and
a plurality of medium outlets, which are arranged on an outer side of the sealing bead facing away from the medium passage opening and which enable medium to flow out of the interior space of the sealing bead.

The medium inlets and the medium outlets by means of which the interior space of the sealing bead is in fluidic connection with the medium passage opening and with the exterior space surrounding the sealing bead respectively are also referred to as gas ports.

These medium inlets and medium outlets or gas ports are arranged on the flanks of the sealing bead and enable the passage of the respective medium from the respective medium channel into a medium distribution region and from there into a medium flow field of the bipolar plate.

In known bipolar plates of the aforementioned kind, there are an equal number of medium inlets and medium outlets.

Starting from this prior art, in accordance with an embodiment of the invention, a bipolar plate of the kind stated at the outset is created, in which the pressure loss that occurs when the medium flows from the medium passage opening through the medium inlets, the interior space of the sealing bead, and the medium outlets is a low as possible, wherein preferably the medium flows out of the medium outlets distributed as uniformly as possible over a medium inlet region of a medium distribution region.

### SUMMARY OF THE INVENTION

In accordance with an embodiment of the invention, a bipolar plate for an electrochemical unit of an electrochemical device having the features of the preamble of claim 1 is provided, in which the total cross-section of the medium inlets that is able to be flowed through is at least 10% greater than the total cross-section of the medium outlets that is able to be flowed through.

The cross-sections of the medium inlets and the medium outlets that are able to be flowed through are hereby taken along a plane that is oriented in parallel to the stack direction and perpendicularly to the average flow direction of the medium through the respective medium inlet or medium outlet.

Underlying the solution in accordance with the invention is the concept of overfilling the interior space of the sealing bead with the respective medium. Because the cross-section of the interior space of the sealing bead itself that is able to be flowed through is significantly larger than the cross-section of the medium inlets and the medium outlets that is able to be flowed through, the flow resistance within the sealing bead hardly contributes to the pressure loss in the medium when said medium flows from the medium passage opening to the outer side of the sealing bead. By increasing the total cross-section of the medium inlets that is able to be flowed through, a maximum medium flow at the medium outlets on the outer side of the sealing bead is achieved.

The average flow speed when flowing through the medium outlets decreases, which reduces the pressure loss in the medium at the medium inlets and also reduces the total pressure loss when the medium passes from the medium passage opening to the outer side of the sealing bead. The total pressure loss is then determined substantially by the flow resistance of the medium outlets.

It is particularly favorable if the total cross-section of the medium inlets that is able to be flowed through is at least 15% greater, particularly preferably at least 20% greater, than the total cross-section of the medium outlets that is able to be flowed through.

In principle, the cross-section of the medium inlets that is able to be flowed through can be influenced by the selection of the number of medium inlets and by the selection of the size of the cross-sectional area of the medium inlets that is able to be flowed through.

Likewise, the total cross-section of the medium outlets that is able to be flowed through can be influenced by the selection of the number of medium outlets and by the selection of the size of the cross-sectional area of the medium outlets that is able to be flowed through.

In a preferred embodiment of the invention, provision is made that the number of medium inlets is greater than the number of medium outlets on the same respective sealing bead.

In this case, the average cross-section of a medium inlet that is able to be flowed through is, for example, substantially equal to the average cross-section of a medium outlet that is able to be flowed through.

It is particularly favorable if the number of medium inlets is greater than the number of medium outlets by two or more.

The medium inlets are preferably arranged along the periphery of the sealing bead offset from the medium outlets.

In a preferred embodiment of the invention, provision is made that the bipolar plate comprises an electrochemically active region, which comprises an anode gas flow field that is able to be flowed through by an anode gas, a cathode gas flow field that is able to be flowed through by a cathode gas, and a coolant flow field that is able to be flowed through by a coolant, wherein the bipolar plate comprises a medium distribution region, by way of which the medium passage opening is in fluidic connection with the electrochemically active region of the bipolar plate.

Anode gas travels from the anode gas flow field of the electrochemically active region, optionally through an anode-side gas diffusion layer, to an anode of a membrane-electrode arrangement. Cathode gas travels from the cathode gas flow field of the electrochemically active region, optionally through a cathode-side gas diffusion layer, to a cathode of a membrane-electrode arrangement. The region of the bipolar plate comprising the anode gas flow field and the cathode gas flow field is therefore also referred to as its electrochemically active region, although no electrochemical reactions take place on the bipolar plate itself.

Preferably, at least one medium outlet is arranged and oriented on the sealing bead such that the medium flows out of the medium outlet directed toward a medium inlet region of the medium distribution region.

For example, provision may be made that a plurality of medium outlets are arranged on a distribution region portion of the sealing bead that is located opposite a medium inlet region of the medium distribution region.

It is particularly favorable if all medium outlets of a sealing bead are arranged on the distribution region portion of the sealing bead that is located opposite the medium inlet region of the medium distribution region.

Furthermore, preferably at least one medium inlet is arranged on the sealing bead outside of the distribution region portion of the sealing bead.

It is particularly favorable if at least two medium inlets, in particular at least three medium inlets, particularly preferably at least four medium inlets, are arranged on the sealing bead outside of the distribution region portion of the sealing bead.

In a preferred embodiment of the invention, provision is made that all medium outlets are arranged on a medium outlet portion of the sealing bead that begins at a first outer medium outlet and ends at a second outer medium outlet. All other medium outlets are then located, distributed along the periphery of the sealing bead, between the first outer medium outlet and the second outer medium outlet.

In this case, it is favorable if at least one medium inlet is arranged on the sealing bead outside of the medium outlet portion of the sealing bead.

Preferably at least two medium inlets, in particular at least three medium inlets, particularly preferably at least four medium inlets, are arranged on the sealing bead outside of the medium outlet portion of the sealing bead.

A longitudinal direction of the bipolar plate preferably extends in parallel to a main flow direction of the medium through a medium flow field of the bipolar plate associated with the medium. Here, preferably at least one medium inlet is arranged and oriented on the sealing bead such that the medium flows through the medium inlet into the interior space of the sealing bead substantially perpendicularly to the longitudinal direction of the bipolar plate.

The longitudinal direction of the bipolar plate is preferably oriented parallel to the long sides of a bipolar plate that is substantially rectangular seen in a plan view along the stack direction.

In order to not negatively influence the mechanical stability and the spring properties of the sealing bead in the curved portions of the sealing bead, it is favorable if no medium inlet is arranged on a curved portion of a rim of the medium passage opening.

This achieves a homogeneous pressing of the sealing bead.

The cross-section of the sealing bead that is able to be flowed through is preferably greater than the average cross-section of a medium flow channel of a medium flow field of the bipolar plate associated with the medium that is able to be flowed through.

The medium passage opening, for the sealing bead of which it is the case that the total cross section of the medium inlets that is able to be flowed through is at least 10% greater than the total cross-section of the medium outlets that is able to be flowed through, may be an anode gas passage opening, a cathode gas passage opening, or a coolant passage opening of the bipolar plate.

It is particularly favorable if it is that case for all sealing beads at the anode gas passage opening, at the cathode gas passage opening, and at the coolant passage opening that the total cross-section of the medium inlets on the respectively associated sealing bead that is able to be flowed through is at least 10% greater than the total cross-section of the medium outlets that is able to be flowed through.

In a preferred embodiment of the invention, provision is accordingly made that an anode gas passage opening, a cathode gas passage opening, and a coolant passage opening of the bipolar plate are all each surrounded by a respective sealing bead on which medium inlets and medium outlets are arranged, wherein the total cross-section of the medium inlets on each of these sealing beads that is able to be flowed through is at least 10% greater, in particular at least 15% greater, particularly preferably at least 20% greater than the total cross-section of the medium outlets on the respective sealing bead that is able to be flowed through.

The bipolar plate in accordance with the invention is suited, in particular, for use as a constituent part of an electrochemical device comprising a plurality of electrochemical units that follow one another along a stack direction and each comprise a respective bipolar plate in accordance with the invention.

Such an electrochemical device may be, for example, a fuel cell device or an electrolyzer.

In a preferred embodiment of the invention, provision is made that the electrochemical device is configured as a polymer electrolyte membrane (PEM) fuel cell device.

Further features and advantages of the invention are the subject matter of the subsequent description and the illustrative depiction of an exemplary embodiment.

### BRIEF DESCRIPTION OF THE DRAWINGS

FIG. 1 shows a plan view of an end region of a bipolar plate for an electrochemical unit of an electrochemical deice comprising a plurality of electrochemical units that follow one another along a stack direction, wherein the bipolar plate comprises a plurality of medium passage openings, which each form a constituent part of a medium channel that extends along the stack direction through the electrochemical device, each comprise a sealing bead that extends around the medium passage opening, each comprise a plurality of medium inlets that are arranged on an inner side of the sealing bead facing toward the medium passage opening and enable medium to flow into the interior space of the sealing bead, and each comprise a plurality of medium outlets that are arranged on an outer side of the sealing bead facing away from the medium passage opening and enable medium to flow out of the interior space of the sealing bead, wherein the total cross-section of the medium inlets on a sealing beads that is able to be flowed through is at least 10% greater than the total cross-section of the medium outlets on the same sealing bead that is able to be flowed through, with the viewing direction toward the cathode side of the bipolar plate;

FIG. 2 shows a plan view of the end region of the bipolar plate from FIG. 1, with the viewing direction toward the anode side of the bipolar plate;

FIG. 3 shows a plan view of the inner side of the end region of an anode-side bipolar plate layer of the bipolar plate from FIGS. 1 and 2; and

FIG. 4 shows a plan view of the inner side of the end region of a cathode-side bipolar plate layer of the bipolar plate from FIGS. 1 and 2.

### DETAILED DESCRIPTION OF THE INVENTION

The same or functionally equivalent elements are provided with the same reference numerals in all Figures.

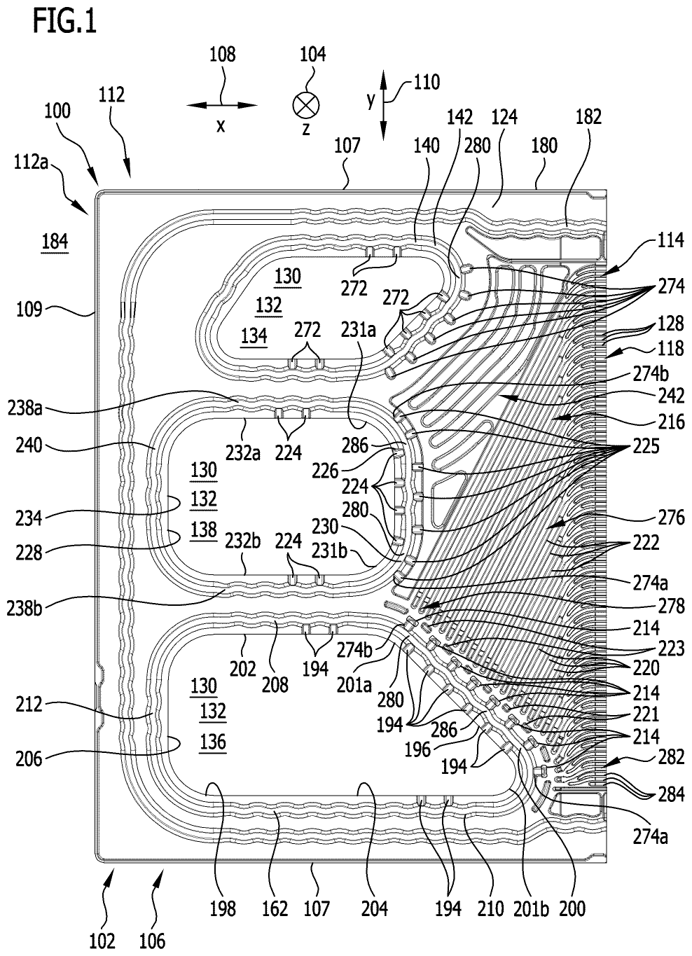

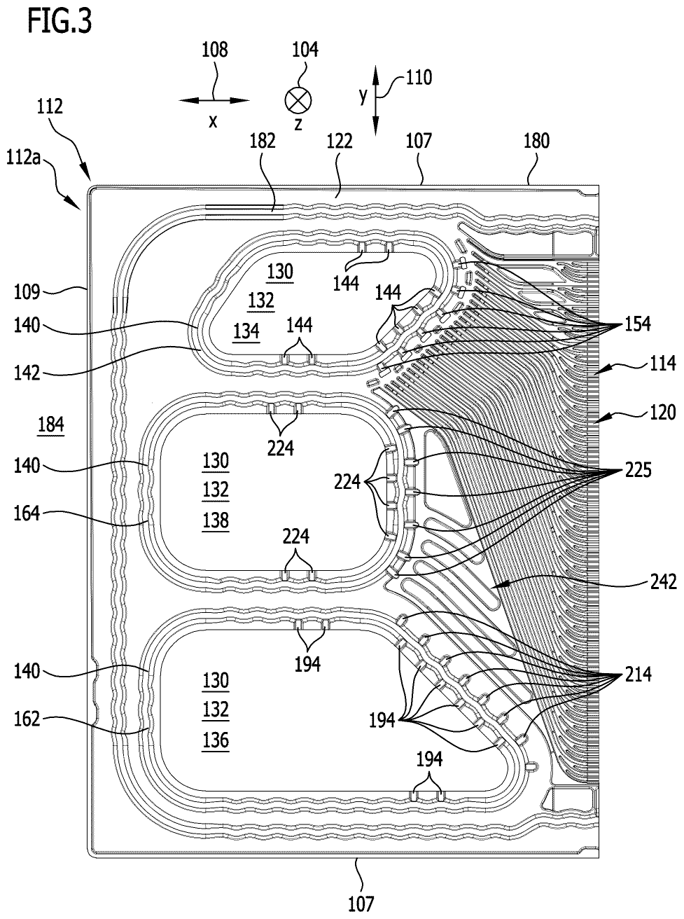

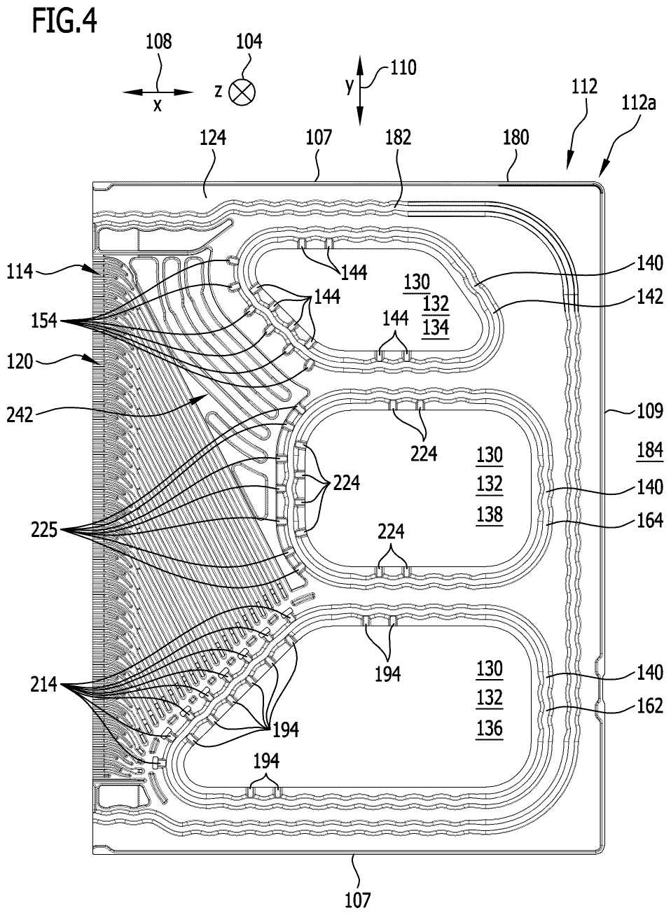

A bipolar plate, depicted sectionally in FIGS. 1 to 4 and denoted as a whole with 100, forms a constituent part of an electrochemical unit 102 (not depicted as a whole), which, in addition to the bipolar plate 100, may comprise a membrane electrode arrangement, gas diffusion layers, and a seal arrangement.

A plurality of such electrochemical units 102 follow one another along a stack direction 104 to form a stack of electrochemical units 102, which is a constituent part of an electrochemical device 106, for example of a fuel cell device.

The bipolar plate 100 has a substantially rectangular shape, wherein long sides 107 of the bipolar plate 100 extend along a longitudinal direction 108 and short sides 109 of the bipolar plate 100 extend along a transverse direction 110 of the bipolar plate 100.

The longitudinal direction 108 and the transverse direction 110 are preferably oriented perpendicularly to one another and perpendicularly to the stack direction 104.

The longitudinal direction 108 is referred to as the x-direction, the transverse direction 110 is referred to as the y-direction, and the stack direction 104 is referred to as the z-direction.

The x-direction, the y-direction, and the z-direction span a right-angled coordinate system.

The bipolar plate 100 has two end regions 112 and an electrochemically active region 114 located between the end regions 112.

The electrochemically active region 114 of the bipolar plate 100 comprises an anode gas flow field 116 that is able to be flowed through by an anode gas, a cathode gas flow field 118 that is able to be flowed through by a cathode gas, and a coolant flow field 120 that is able to be flowed through by a coolant.

In the case of the embodiment described here, the bipolar plate 100 is of two-layer configuration and comprises an anode-side bipolar plate layer 122 on which the anode gas flow field 116 is formed and a cathode-side bipolar plate layer 124 on which the cathode gas flow field 118 is formed.

The bipolar plate layers 122 and 124 consist of a material that has good electrical conductivity, preferably a metallic material.

The bipolar plate layers 122 and 124 are connected to another by a material joint, preferably welded, along joint lines (not depicted), in particular by laser welding.

The anode flow field 116 of the bipolar plate 100 is in fluidic connection with an anode-side electrode of a membrane-electrode arrangement, optionally by way of an anode-side gas diffusion layer.

The cathode flow field 118 of the bipolar plate 100 is in fluidic connection with a cathode-side electrode of a membrane-electrode arrangement, optionally by way of a cathode-side gas diffusion layer.

Anode gas and cathode gas can thus travel from the electrochemically active region 114 of the bipolar plate 100 to the electrochemically active regions of a respective membrane-electrode arrangement. Therefore, the region of the bipolar plate 100 provided with the anode gas flow field 116 and the cathode gas flow field 118 is referred to as its electrochemically active region 114, although no electrochemical reactions take place on the bipolar plate 100 itself.

The anode gas flow field 116 comprises anode gas flow channels 126, the main flow direction of which is oriented in parallel with the longitudinal direction 108 (x-direction) of the bipolar plate 100.

The cathode gas flow field 118 comprises cathode gas flow channels 128, the main flow direction of which extends in parallel with the longitudinal direction 108 (x-direction) of the bipolar plate 100.

In its end regions 112, of which a first end region 112a is depicted in FIGS. 1 to 4, the bipolar plate 100 has in each case a plurality of medium passage openings 130 through which a respective fluid medium to be supplied to the electrochemical device 106 (an anode gas (combustion gas, for example hydrogen), a cathode gas (oxidizer, for example oxygen or air), or a coolant (for example water)) is able to pass through the bipolar plate 100. The medium passage openings 130 of the bipolar plates 100 following one another in the stack of electrochemical units 102 and the interspaces located between the medium passage openings 130 in the stack direction 104 together form a respective medium channel 132.

Associated with each of the medium channels 132 in one of the end regions 112 of the bipolar plate 100, through which a fluid medium is suppliable to the electrochemical device 100, is a respective other medium channel 132 in the respective opposite end region 112, through which the respective fluid medium is dischargeable from the electrochemical device 106.

The fluid media hereby travel through the anode gas flow field 116, the cathode gas flow field 118, and the coolant flow field 120 in the electrochemically active region 114 of the bipolar plate 100 from the one end region 112 to the other end region 112.

Arranged in the first end region 112a of the bipolar plate 100 depicted in FIGS. 1 to 4 are an anode gas passage opening 134, a cathode gas passage opening 136, and a coolant passage opening 138.

In principle, each of these passage openings 134, 136, 138 may hereby selectively serve to supply the respective medium to the electrochemical device 106 or to discharge the respective medium from the electrochemical device 106.

In principle, each of the three media (anode gas, cathode gas, and coolant) can flow through the electrochemically active region 114 in parallel to the respective other media or with an opposite main flow direction relative to the main flow directions of one or two of the other media.

In a preferred embodiment of the invention, provision is made that all passage openings 134, 136, 138 arranged in the first end region 112a of the bipolar plate 100 serve to supply the respective medium to the electrochemical device 106 and the passage openings 134, 136, 138 arranged in the second end region 112 of the bipolar plate 100 serve to discharge the respective medium from the electrochemical device 106.

In order to prevent undesired leakage of the fluid media out of the respectively associated passage openings 134, 136, 138, each of these passage openings is provided with a respective sealing bead 140.

The anode gas passage opening 134 is surrounded by an anode gas sealing bead 142.

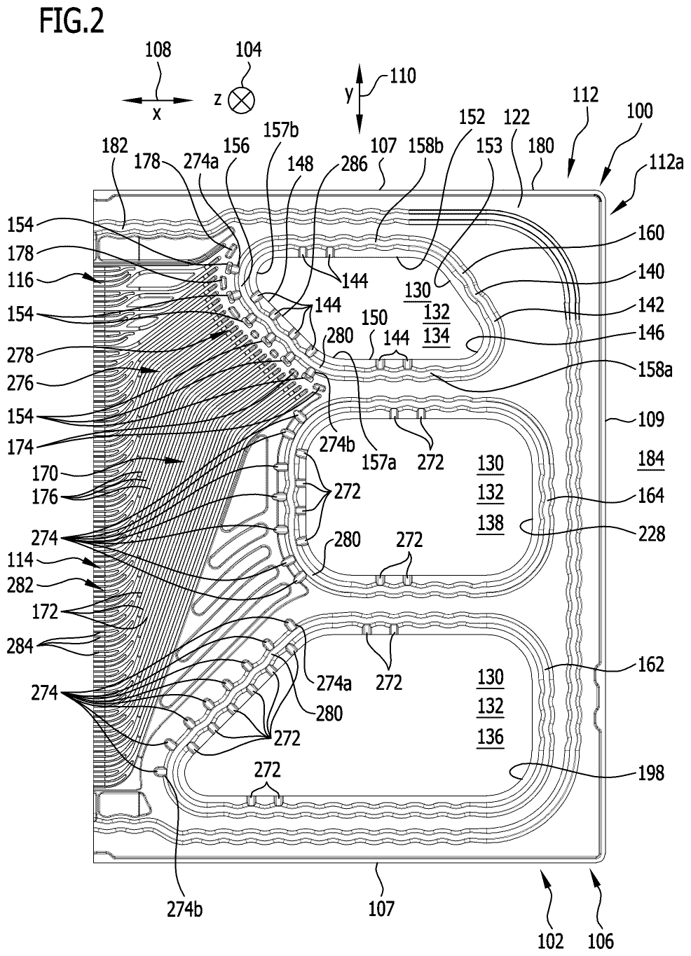

In order to be able to supply the anode gas from the anode gas passage opening 134 to the anode gas flow field 136, the anode gas sealing bead 142 is provided with a plurality of anode gas inlets 144 on its inner side facing toward the anode gas passage opening 134, through which anode gas inlets anode gas is able to flow from the anode gas passage opening 134 into the interior space of the anode gas sealing bead 142 (see FIG. 2).

The anode gas inlets 144 each open on a rim 146 of the anode gas passage opening 134.

Provision is preferably made that the anode gas inlets 144 each open on a rectilinear rim portion 148, 150, or 152 of the anode gas passage opening 134.

The rectilinear rim portion 148 extends obliquely to the longitudinal direction 108 (x-direction) of the bipolar plate 100 and obliquely to the transverse direction 110 (y-direction) of the bipolar plate 100 and preferably faces toward the electrochemically active region 114 of the bipolar plate 100.

Preferably, arranged on the rim portion 148 are a plurality of anode gas inlets, preferably at least three, namely four in the embodiment depicted, through which the anode gas flows preferably perpendicularly to the longitudinal direction 108 (x-direction) of the bipolar plate 100 into the interior space of the anode gas sealing bead 142.

The rectilinear rim portion 150 preferably extends substantially in parallel to the longitudinal direction 108 (x-direction) of the bipolar plate 100 and preferably faces toward the coolant passage opening 138.

One or more anode gas inlets 144, namely two anode gas inlets 144 in the embodiment depicted, open on the rim portion 150.

The rectilinear rim portion 152 preferably extends substantially in parallel to the longitudinal direction 108 (x-direction) of the bipolar plate 100 and preferably faces away from the coolant passage opening 138.

Preferably, one or more anode gas inlets 144, namely two anode gas inlets 144 in the embodiment depicted, open on the rim portion 152, through which anode gas inlets 144 the anode gas flows preferably perpendicularly to the longitudinal direction 108 (x-direction) of the bipolar plate 100 into the interior space of the anode gas sealing bead 142.

The rim 146 of the anode gas passage opening 134 further comprises a rectilinear portion 153, which is preferably oriented obliquely to the longitudinal direction 108 (x-direction) of the bipolar plate 100 and obliquely to the transverse direction 110 (y-direction) of the bipolar plate 100 and preferably faces away from the electrochemically active region 114 of the bipolar plate 100.

Preferably no anode gas inlet 144 opens on the rim portion 153.

The rim portions 148, 150, 152, and 153 together form a polygonal rim 146 of the anode gas passage opening 134.

In the graphically depicted embodiment, the rim 146 of the anode gas passage opening 134 is of quadrangular configuration; the polygonal rim 146 of the anode gas passage opening 134 may also have more or fewer than four corners.

The corners of the anode gas passage opening 134 are preferably of rounded configuration in order to prevent tearing of the bipolar plate layers 122 and 124 in the region of said corners.

In order to enable the exit of the anode gas from the interior space of the anode gas sealing bead 142, the anode gas sealing bead 142 is provided with a plurality of anode gas outlets 154 on its outer side facing away from the anode gas passage opening 134.

The anode gas outlets 154 are preferably arranged on a portion 156 of the anode gas sealing bead 142 that faces toward the electrochemically active region 114 of the bipolar plate 100.

The portion 156 of the anode gas sealing bead 142 preferably extends substantially in parallel to the rectilinear rim portion 148 of the rim 146 of the anode gas passage opening 134 and substantially in parallel to the rounded corner regions 157a and 157b of the rim 146, which connect the rectilinear rim portion 148 to the rim portion 150 and to the rim portion 152 respectively.

Here, preferably a plurality of anode gas outlets 154, preferably at least four, namely six in the embodiment depicted, are arranged on the portion 156.

The anode gas inlets 144 that are arranged on the same portion 156 of the anode gas sealing bead 142 are preferably offset relative to the anode gas outlets 154 along the peripheral direction of the anode gas sealing bead 142.

Furthermore, the anode gas sealing bead 142 comprises further portions 158a, 158b, and 160, which are each oriented substantially in parallel to the rectilinear rim portions 150 and 152 extending in parallel to the longitudinal direction 108 of the bipolar plate 100 and oriented substantially in parallel to the rectilinear rim portion 153 of the rim 146 of the anode gas passage opening 134 facing away from the electrochemically active region 114.

The anode gas flows through the anode gas outlets 154 on the portion 156 of the anode gas sealing bead 142 into an anode gas distribution region 170, which serves to distribute the anode gas as uniformly as possible to the anode gas flow channels 126 of the anode gas flow field 116.

The anode gas distribution region 170 comprises a plurality of respective directed distribution structures 172 and a plurality of respective undirected distribution structures 174, which serve to deflect the anode gas from its original flow direction.

The directed distribution structures 172 are hereby configured, e.g., as substantially linearly extending distribution webs 176.

The undirected distribution structures 174 are configured, e.g., as substantially bowl-shaped distribution nubs 178.

The distribution structures 172 and 174, like all other structures of the bipolar plate 100 described in the preceding and in the following, are preferably formed in one piece with the material of the bipolar plate layers 122 or 124 and are introduced into the respective bipolar plate layer 122 and 124 by a reshaping operation, for example by a stamping operation or a deep-drawing operation.

The cathode gas passage opening 136 is surrounded by a cathode gas sealing bead 162.

The coolant passage opening 138 is surrounded by a coolant sealing bead 164.

An annularly closed rim bead 182 extends around near the outer rim 180 of the bipolar plate 100.

The rim bead 182 encloses the electrochemically active region 114 of the bipolar plate 100, the anode gas passage openings 134, and the anode gas sealing beads 142 in both end regions 112, the cathode gas passage openings 136 and the cathode gas sealing beads 162 in both end regions 112, and the coolant passage openings 138 and the coolant sealing beads 164 in both end regions 112 of the bipolar plate 100.

The rim bead 182 serves to prevent leakage of the media to be supplied to the electrochemical device 106, in particular the anode gas, the cathode gas, and the coolant, from the electrochemical units 102 into the outside space 184 of the electrochemical device 106.

In order to allow the cathode gas to flow out of the cathode gas passage opening 136 through the cathode gas sealing bead 162, the cathode gas sealing bead 162 is provided with a plurality of cathode gas inlets 194 on its inner side facing toward the cathode gas passage opening 136 (see in particular FIG. 1).

Cathode gas travels from the cathode gas passage opening 136 through the cathode gas inlets 194 into the interior space of the cathode gas sealing bead 162.

The cathode gas inlets 194 preferably open on rim portions 196, 202, and 204 of the rim 198 of the cathode gas passage opening 136.

The rectilinear rim portion 196 preferably extends obliquely to the longitudinal direction 108 (x-direction) of the bipolar plate 100 and obliquely to the transverse direction 110 (y-direction) of the bipolar plate 100 and preferably faces toward the electrochemically active region 114 of the bipolar plate 100. Preferably a plurality of cathode gas inlets 194, in particular at least four, namely six in the embodiment depicted, open on the rim portion 196.

The rectilinear rim portion 202 preferably extends substantially in parallel to the longitudinal direction 108 (x-direction) of the bipolar plate 100 and preferably faces toward the coolant passage opening 138. Preferably, one or more cathode gas inlets 194, namely two cathode gas inlets 194 in the embodiment depicted, open on the rim portion 202, through which cathode gas inlets 194 the cathode gas flows preferably perpendicularly to the longitudinal direction 108 (x-direction) of the bipolar plate 100 into the interior space of the cathode gas sealing bead 162.

The rectilinear rim portion 204 preferably extends substantially in parallel to the longitudinal direction 108 (x-direction) of the bipolar plate 100 and preferably faces toward the rim bead 182.

Preferably, one or more cathode gas inlets 194, namely two cathode gas inlets 194 in the embodiment depicted, open on the rim portion 204, through which cathode gas inlets 194 the cathode gas flows preferably perpendicularly to the longitudinal direction 108 (x-direction) of the bipolar plate 100 into the interior space of the cathode gas sealing bead 162.

Furthermore, the rim 198 of the cathode gas passage opening 136 may comprise a rectilinear rim portion 206, which extends substantially in parallel to the transverse direction 110 (y-direction) of the bipolar plate 100 and preferably faces away from the electrochemically active region 114 of the bipolar plate 100.

The rim portions 196, 202, 204, and 206 together form a polygonal rim 198 of the cathode gas passage opening 136.

In the graphically depicted embodiment, the rim 198 of the cathode gas passage opening 136 is of quadrangular configuration. The number of corners of the polygonal rim 198 may also be smaller or greater than four.

A plurality of cathode gas outlets 214, for example four or more, preferably six or more, namely eight in the embodiment depicted, are arrange on the outer side of a portion 200 of the cathode gas sealing bead 162, which extends substantially in parallel to the rectilinear rim portion 196 of the rim 198 of the cathode gas passage opening 136 and substantially in parallel to the rounded corner regions 201a and 201b of the rim 198, which connect the rectilinear rim portion 196 to the rim portion 202 and the rim portion 204 respectively.

Furthermore, the cathode gas sealing bead 162 comprises further portions 208, 210, and 212, which are each oriented substantially in parallel to the rectilinear rim portions 202 and 204 extending in parallel to the longitudinal direction 108 of the bipolar plate 100 and oriented substantially in parallel to the rectilinear rim portion 206 of the rim 198 of the cathode gas passage opening 136 facing away from the electrochemically active region 114.

The cathode gas outlets 214 are preferably all arranged on a portion 200 of the cathode gas sealing bead 162 that faces toward the electrochemically active region 114 of the bipolar plate 100.

The cathode gas inlets 194 that are arranged on the same portion 200 of the cathode gas sealing bead 162 are preferably arranged offset relative to the cathode gas outlets 214 along the peripheral direction of the cathode gas sealing bead 162.

Preferably, a total of two or more cathode gas outlets 214, in particular four or more, particularly preferably six or more, namely eight in the embodiment depicted, are provided on the cathode gas sealing bead 162.

The cathode gas flows through the cathode gas outlets 214 into a cathode gas distribution region 216 of the bipolar plate 100, which serves to distribute the cathode gas as uniformly as possible to the cathode gas flow channels 128 of the cathode gas flow field 118.

For this purpose, the cathode gas distribution region comprises distribution structures 218, which are configured as directed distribution structures 220 or as undirected distribution structures 221.

The directed distribution structures 220 are preferably configured as linearly extending distribution webs 222.

The undirected distribution structures 221 are configured, e.g., as substantially bowl-shaped distribution nubs 223.

In order to allow the coolant to flow out of the coolant passage opening 138 into the coolant flow field 120 of the bipolar plate 100, the coolant sealing bead 164 is provided with a plurality of coolant inlets 224 on its inner side facing toward the coolant passage opening 138 (see in particular FIG. 1).

The coolant travels from the coolant passage opening 138 through the coolant inlets 224 into the interior space of the coolant sealing bead 164.

The coolant inlets 224 preferably open on rectilinear rim portions 226, 232a, and 232b of the rim 228 of the coolant passage opening 138.

The rectilinear rim portion 226 preferably extends substantially in parallel to the transverse direction 110 (y-direction) of the bipolar plate 100 and preferably faces toward the electrochemically active region 114 of the bipolar plate 100. Preferably a plurality of coolant inlets 224, in particular at least three, namely four in the embodiment depicted, open on the rim portion 226.

The rectilinear rim portion 232a preferably extends substantially in parallel to the longitudinal direction 108 (x-direction) of the bipolar plate 100 and preferably faces toward the anode gas passage opening 134. Preferably, one or more coolant inlets 224, namely two in the embodiment depicted, open on the rim portion 232a, through which coolant inlets 224 the coolant flows preferably perpendicularly to the longitudinal direction 108 (x-direction) of the bipolar plate 100 into the interior space of the coolant sealing bead 164.

The rectilinear rim portion 232b preferably extends substantially in parallel to the longitudinal direction 108 (x-direction) of the bipolar plate 100 and preferably faces toward the cathode gas passage opening 136. Preferably, one or more coolant inlets 224, namely two in the embodiment depicted, open on the rim portion 232b, through which coolant inlets 224 the coolant flows preferably perpendicularly to the longitudinal direction 108 (x-direction) of the bipolar plate 100 into the interior space of the coolant sealing bead 164.

Furthermore, the rim 228 of the coolant passage opening 138 may comprise a rectilinear rim portion 234, which extends substantially in parallel to the transverse direction 110 (y-direction) of the bipolar plate 100 and preferably faces away from the electrochemically active region 114 of the bipolar plate 100. Preferably no coolant inlet 224 opens on the rim portion 234.

The rim portions 226, 232a, 232b, and 234 together form a polygonal rim 228 of the coolant passage opening 138, which is of quadrangular configuration in the embodiment that is graphically depicted. The number of corners of the polygonal rim 228 of the coolant passage opening 138 may also be greater or smaller than four.

A plurality of coolant outlets 225, for example three or more, preferably five or more, namely seven in the embodiment depicted, are arranged on a portion 230 of the coolant sealing bead 164 that extends substantially in parallel to the rectilinear rim portion 226 of the rim 228 of the coolant passage opening 138 and substantially in parallel to the rounded corner regions 231a and 231b of the rim 228, which connect the rectilinear rim portion 226 to the rim portion 232a and to the rim portion 232b respectively. The portion 200 of the coolant sealing bead 164 preferably faces toward the electrochemically active region 114 of the bipolar plate 100.

The coolant inlets 224 that are arranged on the same portion 230 of the coolant sealing bead 164 are preferably arranged offset relative to the coolant outlets 225 along the peripheral direction of the coolant sealing bead 164.

In addition to the portion 230 provided with the coolant outlets 225, the coolant sealing bead 164 preferably comprises further portions 238a, 238b, and 240, which are each oriented substantially in parallel to the rim portions 232a, 232b and 234 respectively of the rim 228 of the coolant passage opening 138.

These further portions 238a, 238b, and 240 of the coolant sealing bead 164 are preferably not provided with coolant outlets 225.

The coolant flows through the coolant outlets 225 into a coolant distribution region 242 of the bipolar plate 100, which serves to distribute the coolant as uniformly as possible to the coolant flow channels of the coolant flow field.

In this coolant distribution region 242, the anode-side bipolar plate layer 122 and the cathode-side bipolar plate layer 124 are arranged offset in opposite directions along the stack direction 104 relative to a longitudinal median plane of the bipolar plate 100 oriented perpendicularly to the stack direction 104 in such a way that a large cross-section that is able to be flowed through is available for the flow of the coolant through the coolant distribution region 242.

The bipolar plate 100 is preferably of rotationally symmetrical configuration with respect to a rotation by 180° about a rotational axis extending through the midpoint of the electrochemically active region 114 of the bipolar plate 100 and in parallel to the stack direction 104 (z-direction).

The medium passage openings 130 arranged in the second end region 112, in particular the anode gas passage opening 134 arranged there, the cathode gas passage opening 136 arranged there, and the coolant passage opening 138 arranged there, are therefore preferably structured and arranged substantially identically to the anode gas passage opening 134, the cathode gas passage opening 136, and the coolant passage opening 138, respectively, in the first end region 112a, which have been described above.

The anode gas inlets 144 form medium inlets 272 on the anode gas sealing bead 142. The anode gas outlets 154 form medium outlets 274 on the anode gas sealing bead 142.

The cathode gas inlets 194 form medium inlets 272 on the cathode gas sealing bead 162. The cathode gas outlets 214 form medium outlets 274 on the cathode gas sealing bead 162.

The coolant inlets 224 form medium inlets 272 on the coolant sealing bead 164. The coolant outlets 225 form medium outlets 274 on the coolant sealing bead 164.

With the bipolar plate 100 depicted in FIGS. 1 to 4 and described above, the aim is to reduce the pressure drop in the media to be supplied to the electrochemical device 106 when said media pass through the respectively associated sealing beads 140. For this purpose, it is favorable if the total cross-section of the respective medium inlets 272 on the respective sealing bead 140 that is able to be flowed through is at least 10% greater, in particular at least 15% greater, particularly preferably at least 20% greater than the total cross-section of the medium outlets 274 on the same sealing bead 140 that is able to be flowed through.

This can be achieved, in particular, in that the cross-section of a medium inlet 272 on a sealing bead 140 that is able to be flowed through is substantially equal to the cross-section of a medium outlet 274 on the seam sealing bead 140 that is able to be flowed through, but the number of medium inlets 272 on the sealing bead 140 is greater than the number of medium outlets 274. Preferably, the number of medium inlets 272 is greater than the number of medium outlets 274 by two or more.

Thus, in the graphically depicted embodiment, provision is made that on the anode gas sealing bead 142 eight anode gas inlets 144 are arranged on the inner side of the anode gas sealing bead 142 facing toward the anode gas passage opening 134, while six anode gas outlets 154 are arranged on the outer side of the anode gas sealing bead 142 facing away from the anode gas passage opening 134.

This significantly reduces the pressure loss in the anode gas when the anode gas flows out of the anode gas passage opening 134 through the anode gas sealing bead 142 into the anode gas distribution region 170.

Furthermore, in the graphically depicted embodiment of a bipolar plate 100, provision is made that ten cathode gas inlets 194 are arranged on the inner side of the cathode gas sealing bead 162 facing toward the cathode gas passage opening 136, while eight cathode gas outlets 214 are arranged on the outer side of the cathode gas sealing bead 162 facing away from the cathode gas passage opening 136.

This significantly reduces the pressure drop in the cathode gas when the cathode gas flows out of the cathode gas passage opening 136 through the cathode gas sealing bead 162 into the cathode gas distribution region 216.

Furthermore, in the graphically depicted embodiment, provision is made that eight coolant inlets 224 are arranged on the inner side of the coolant sealing bead 164 facing toward the coolant passage opening 138, while seven coolant outlets 225 are arranged on the outer side of the coolant sealing bead 164 facing away from the coolant passage opening 138.

This significantly reduces the pressure drop in the coolant when the coolant flows out of the coolant passage opening 138 through the coolant sealing bead 164 into the coolant distribution region 242.

The anode gas distribution region 170 forms a medium distribution region 276 for the anode gas.

The cathode gas distribution region 216 forms a medium distribution region 276 for the cathode gas.

The coolant distribution region 242 forms a medium distribution region 276 for the coolant.

Each of the medium distribution regions 276 comprises a medium inlet region 278 through which the respective medium enters the respective medium distribution region 276.

That portion of a sealing bead 140 that faces toward the electrochemically active region 114 of the bipolar plate 100 forms a distribution region portion 280 of the respective sealing bead 140.

The anode gas flow field 116 forms a medium flow field 282 for the anode gas.

The cathode gas flow field 118 forms a medium flow field 282 for the cathode gas.

The coolant flow field 120 forms a medium flow field 282 for the coolant.

Each of the medium flow fields 282 of the bipolar plate 100 comprises medium flow channels 284, which extend along a main flow direction of the medium through the respective medium flow field 282.

For all medium inlets 272, it is the case that they are preferably arranged offset from the respective medium outlets 274 along the periphery of the respective sealing bead 140.

Each of the medium outlets 274 is preferably arranged and oriented on the respective sealing bead 140 such that the medium flowing through the medium outlet 274 flows out of the medium outlet 274 directed toward a medium inlet region 278 of the respectively associated medium distribution region 276.

Preferably, all medium outlets 274 are arranged on the distribution region portion 280 of the respective sealing bead 140 that is located opposite the medium inlet region 278 of the respectively associated medium distribution region 276.

In the case of each of the medium passage openings 130, preferably at least one respective medium inlet 272 is arranged on the respective sealing bead 140 outside of the distribution region portion 280 of the respective sealing bead 140.

Preferably, in the case of each of the medium passage openings 130, at least two medium inlets 272, in particular at least three, particularly preferably at least four, are arranged on the respective sealing bead 140 outside of the distribution region portion 280 of the respective sealing bead 140.

On each of the sealing beads 140, a medium outlet portion 286 of the respective sealing bead 140 is defined in that it begins at a first outer medium outlet 274a and ends at a second outer medium outlet 274b.

Preferably, in the case of each sealing bead 140, provision is made that at least one medium inlet 272 is arranged on the respective sealing bead 140 outside of the medium outlet portion 286 of the respective sealing bead 140.

The longitudinal direction 108 (x-direction) of the bipolar plate 100 extends in parallel to a main flow direction of the media through the medium flow fields 282 associated with the respective media.

Preferably, on each sealing bead 140, at least one medium inlet 272 is arranged and oriented on the respective sealing bead 140 such that the medium flows through the respective medium inlet 272 into the interior space of the respective sealing bead 140 substantially perpendicularly to the longitudinal direction 108, i.e. substantially in parallel to the transverse direction 110, of the bipolar plate 100.

In order to not negatively influence the mechanical stability and the spring properties of the sealing beads 140 in their curved portions, provision is preferably made that no medium inlet 272 is arranged on a curved portion of a rim of the respective medium passage opening 130.

For each of the sealing beads 140, it is the case the cross-section of the respective sealing bead 140 that is able to be flowed through is preferably greater than the average cross-section of a medium flow channel 284 of the medium flow field 282 of the bipolar plate 100 associated with the respective medium that is able to be flowed through.

1. A bipolar plate for an electrochemical unit of an electrochemical device comprising a plurality of electrochemical units that follow one another along a stack direction, wherein the bipolar plate comprises the following:
at least one medium passage opening, which forms a constituent part of a medium channel that extends along the stack direction through the electrochemical device;
a sealing bead, which extends around the medium passage opening;
a plurality of medium inlets, which are arranged on an inner side of the sealing bead facing toward the medium passage opening and which enable medium to flow into an interior space of the sealing bead; and
a plurality of medium outlets, which are arranged on an outer side of the sealing bead facing away from the medium passage opening and which enable medium to flow out of the interior space of the sealing bead;
wherein the total cross-section of the medium inlets that is able to be flowed through is at least 10% greater than the total cross-section of the medium outlets that is able to be flowed through.

2. The bipolar plate in accordance with claim 1, wherein the number of medium inlets is greater than the number of medium outlets.

3. The bipolar plate in accordance with claim 1, wherein the medium inlets are arranged along the periphery of the sealing bead offset from the medium outlets.

4. The bipolar plate in accordance with claim 1, wherein the bipolar plate comprises an electrochemically active region, which comprises an anode gas flow field that is able to be flowed through by an anode gas, a cathode gas flow field that is able to be flowed through by a cathode gas, and a coolant flow field that is able to be flowed through by a coolant, wherein the bipolar plate comprises a medium distribution region, by way of which the medium passage opening is in fluidic connection with the electrochemically active region of the bipolar plate.

5. The bipolar plate in accordance with claim 4, wherein at least one medium outlet is arranged and oriented on the sealing bead such that the medium flows out of the medium outlet directed toward a medium inlet region of the medium distribution region.

6. The bipolar plate in accordance with claim 4, wherein a plurality of medium outlets are arranged on a distribution region portion of the sealing bead that is located opposite a medium inlet region of the medium distribution region.

7. The bipolar plate in accordance with claim 6, wherein at least one medium inlet is arranged on the sealing bead outside of the distribution region portion of the sealing bead.

8. The bipolar plate in accordance with claim 1, wherein all medium outlets are arranged on a medium outlet portion of the sealing bead that begins at a first outer medium outlet and ends at a second outer medium outlet.

9. The bipolar plate in accordance with claim 8, wherein at least one medium inlet is arranged on the sealing bead outside of the medium outlet portion of the sealing bead.

10. The bipolar plate in accordance with claim 1, wherein a longitudinal direction of the bipolar plate extends in parallel to a main flow direction of the medium through a medium flow field of the bipolar plate associated with the medium, wherein at least one medium inlet is arranged and oriented on the sealing bead such that the medium flows through the medium inlet into the interior space of the sealing bead substantially perpendicularly to the longitudinal direction of the bipolar plate.

11. The bipolar plate in accordance with claim 1, wherein no medium inlet is arranged on a curved portion of a rim of the medium passage opening.

12. The bipolar plate in accordance with claim 1, wherein the cross-section of the sealing bead that is able to be flowed through is greater than the average cross-section of a medium flow channel of a medium flow field of the bipolar plate associated with the medium that is able to be flowed through.

13. The bipolar plate in accordance with claim 1, wherein the medium passage opening is an anode gas passage opening, a cathode gas passage opening, or a coolant passage opening.

14. The bipolar plate in accordance with claim 1, wherein an anode gas passage opening, a cathode gas passage opening, and a coolant passage opening of the bipolar plate are all each surrounded by a respective sealing bead on which medium inlets and medium outlets are arranged, wherein the total cross-section of the medium inlets on each of these sealing beads that is able to be flowed through is at least 10% greater than the total cross-section of the medium outlets on the respective sealing bead that is able to be flowed through.

15. An electrochemical device, comprising a plurality of electrochemical units that follow one another along a stack direction and each comprise a bipolar plate for an electrochemical unit of the electrochemical device, wherein the bipolar plate comprises the following:
at least one medium passage opening, which forms a constituent part of a medium channel that extends along the stack direction through the electrochemical device;
a sealing bead, which extends around the medium passage opening;
a plurality of medium inlets, which are arranged on an inner side of the sealing bead facing toward the medium passage opening and which enable medium to flow into an interior space of the sealing bead; and
a plurality of medium outlets, which are arranged on an outer side of the sealing bead facing away from the medium passage opening and which enable medium to flow out of the interior space of the sealing bead;
wherein the total cross-section of the medium inlets that is able to be flowed through is at least 10% greater than the total cross-section of the medium outlets that is able to be flowed through.
